(19) United States
(12) Patent Application Publication
(10) Pub. No.: US 2017/0190901 A1
(43) Pub. Date: Jul. 6, 2017

(54) FORMULATION OF NOVOLAK RESINS FOR ENHANCING THE ACID RESISTANCE OF POLYAMIDE COMPOSITIONS

(71) Applicant: Rhodia Operations, Paris (FR)

(72) Inventors: Gilles Orange, Vourles (FR); Mathilde Mercier, Lyon (FR)

(73) Assignee: Rhodia Operations, Paris (FR)

(21) Appl. No.: 15/463,895

(22) Filed: Mar. 20, 2017

Related U.S. Application Data
(62) Division of application No. 13/060,375, filed on May 12, 2011.

(30) Foreign Application Priority Data
Aug. 25, 2008 (FR) 0804684

(51) Int. Cl. C08L 61/06; C08L 77/06; C10G 31/09

(52) U.S. Cl. CPC C08L 61/06; C10G 31/09; C08L 77/06

(57) ABSTRACT

Novolak resins ere incorporated for enhancing the acid resistance of polyamide compositions. Polyamide compositions containing such novolak resins are useful for producing various plastic shaped articles, such as calibrated particles or injection-molded parts, and are particularly useful for the recovery of sludge, liquids, and gases present in underground reservoirs, especially in the field of hydrocarbon extraction such as crude oil or natural gas.

The present invention relates to the use of a novolac resin for increasing the acid resistance of a polyamide composition. The invention also relates to a polyamide composition comprising novolac resin and to its use for the manufacture of various plastic articles such as, for example, calibrated particles or injected-molded parts. Said composition is especially used in the field of the recovery of muds, liquids and gases present in underground reservoirs, and in particular in the field of the extraction of hydrocarbons, such as crude oil or natural gas.

### PRIOR ART

Polyamide-based thermoplastic compositions are raw materials that can be converted to plastic articles and parts, especially via various forming processes.

In very many fields of activity, it may prove necessary to be able to provide materials that have high mechanical properties and also a high acid resistance. As an application, mention may especially be made of the pipes and tanks in the automotive field. There is also a need in the field of filtration (gravel packing) materials within the context of the extraction of hydrocarbons, such as crude oil or natural gas. Indeed, thermoplastic materials, especially made of polyamide, in the form of calibrated particles are introduced by pumping into underground reservoirs to act, according to a filtration mechanism, in order to minimize the flow of fine particles of rock, sand and other impurities liable to be present in the reservoir, into the muds, liquids and gases that have to be extracted from the well. However, these filtration materials are cleaned by injection of acids or of acid sludges, especially of HCl and/or HF type.

However, in view of the temperatures and pressures exerted on the polyamide in certain applications, especially in gravel packing, it is difficult to find formulations, especially based on conventional polyamides, which have good acid resistances and which make it possible to meet the specifications for this application within the context of the extraction of hydrocarbons.

### INVENTION

The Applicant has discovered, entirely surprisingly, that the use of a novolac resin in a polyamide-based composition makes it possible to increase the resistance to acids, especially to formulations comprising HCl and/or HF. An optimum level of compromise between the acid resistance and the mechanical properties is especially obtained when the polyamide composition comprises from 5 to 40% by weight of novolac resin, relative to the total weight of the composition.

It is known practice from the prior art to use a novolac resin for providing dimensional stability to a polyamide composition, especially while avoiding water uptake of said polyamide. However, it has never been demonstrated that a novolac resin can play a role in the acid resistance of a polyamide composition.

The main subject of the present invention is the use of a novolac resin for increasing the acid resistance of a polyamide composition. The invention especially relates to a method for increasing the acid resistance of a polyamide composition in which at least novolac resin is melt blended with polyamide resin.

The expression “acid resistance” is understood to mean in particular retaining the mechanical properties and the molecular weight of the polyamide and/or a limited loss of mass of the composition after exposure to various chemical agents of an acid nature, such as for example HCl and/or HF.

As polyamides that may be used according to the invention, mention may be made of semicrystalline or amorphous polyamides and copolyamides, such as aliphatic polyamides, semiaromatic polyamides and, more generally, linear polyamides obtained by polycondensation between a saturated aliphatic or aromatic diacid and a saturated aliphatic or aromatic primary diamine, polyamides obtained by condensation of a lactam or an amino acid, or linear polyamides obtained by condensation of a mixture of these various monomers. Mora specifically, these copolyamides may be, for example, polyhexamethylene adipamide, polyphthalamides obtained from terephthalic and/or isophthalic acid, and copolyamides obtained from adipic acid, hexamethylenediamine and caprolactam.

According to one preferential embodiment of the invention, the polyamide is selected from the group consisting of the polyamide PA-6, the polyamide PA-6,6, the polyamide PA-6,10, the polyamide PA-11, the polyamide PA-12, the polyamide PA-6,12, poly(meta-xylylene adipamide) (MXD6), the polyamide PA-6,6/6,T, the polyamide PA-6,6/6,1, and blends and copolyamides, such as the copolyamide PA-6/6,6 for example.

The composition of the invention may also comprise copolyamides derived especially from the above polyamides, or blends of these polyamides or copolyamides.

The preferred polyamides are polyhexamethylene adipamide, polycaprolactam, or copolymers and blends of polyhexamethylene adipamide and polycaprolactam.

Polyamides whose molecular weights are suited to injection-molding processes, for example with a viscosity index VI of between 100 and 160 ml/g, according to standard ISO 307, are generally used; however, polyamides of lower viscosity may also be used.

The polyamide matrix may especially be a polymer comprising star-shaped or H-shaped macromolecular chains and, where appropriate, linear macromolecular chains. Polymers comprising such star-shaped or H-shaped macromolecular chains are described, for example, in documents FR 2 743 077, FR 2 779 730, U.S. Pat. No. 5,959,069, EP 0 632 703, EP 0 682 057 and EP 0 832 149.

According to another particular variant of the invention, the polyamide matrix of the invention may be a polymer of random tree type, preferably a copolyamide having a random tree structure. These copolyamides of random tree structure and the process for obtaining them are described especially in document WO 99/03909. The matrix of the invention may also be a composition comprising a linear thermoplastic polymer and a star-shaped, H-shaped and/or tree-type thermoplastic polymer as described above. The matrix of the invention may also comprise a hyperbranched copolyamide of the type of those described in document WO 00/68298. The composition of the invention may also comprise any combination of linear, star-shaped, H-shaped and tree-type thermoplastic polymers or hyperbranched copolyamides as described above.

The composition according to the invention preferentially contains from 40 to 90% by weight of polyamide, relative to the total weight of the composition.

Novolac resins are generally condensation products of phenolic compounds with aldehydes or ketones; in particular a condensation product of at least one phenolic compound with at least one aldehyde and/or one ketone. These condensation reactions are generally catalyzed with an acid or a base.

The polyamide according to the invention may comprise one or more different types of novolac resin.

The novolac resins generally have a degree of condensation between 2 and 15.

The phenolic compounds may be chosen, alone or as a mixture, from phenol, cresol, xylenol, naphthol, alkylphenols, such as butylphenol, tert-butylphenol, isooctylphenol, nitrophenol, phenylphenol, resorcinol or bisphenol A; or any other substituted phenol.

The aldehyde used most frequently is formaldehyde. However, others may be used, such as acetaldehyde, para-formaldehyde, butyraldehyde, crotonaldenyde, glycoxal and furfural.

As ketone, it is possible to use acetone, methyl ethyl ketone or acetophenone.

According to one particular embodiment of the invention, the resin is a condensation product of phenol and formaldehyde.

The novolac resins used advantageously have a molecular weight between 500 and 3000 g/mol, preferably between 800 and 2000 g/mol.

As commercial novolac resin, mention may especially be made of the commercial products Durez®, Vulkadur® or Rhenosin®.

The composition may comprise from 5 to 40% by weight of novolac resin, more preferably from 10 to 25% by weight, relative to the total weight of the composition.

The polyamide composition according to the invention comprising novolac resin is especially used as a matrix, especially via granulation, calendering, injection, molding, injection molding, pressing, etc.

It is thus possible for example to prepare granules, chips, pellets, ingots, of all spherical, flat or ovoid shapes, in the form of drops, prisms, parallelepipeds, cylinders, pads, etc. According to one embodiment and advantageously for drilling well fracturing or filtering applications, the material of the invention is advantageously in the form of granules, pellets and/or cylinders, flattened or not.

In particular, when the material is in the form of substantially spherical or ellipsoidal pellets, they can be prepared by an underwater cutting process, as described for example in patents U.S. Pat. No. 2,918,701 and U.S. Pat. No. 3,749,539 or else in patent application US 2005/0035483. This process uses a die head provided with holes and fed with the thermoplastic matrix in the melt state, comprising the fillers and optionally one or more additives as described previously. The underwater die head is provided with a rotary knife-holder, the blades of which cut the molten material issuing from the die holes, and the water bath in which the cutting head is submerged allows for rapid cooling of the pellets formed.

To improve the mechanical properties of a polyamide composition according to the invention, it may be advantageous to add thereto at least one reinforcing and/or bulking filler, such as fibrous or non-fibrous fillers, preferably selected from the group consisting of glass fibers, carbon fibers, aramid fibers, clays, kaolin, mica, wollastonite, silica, talc, graphite, silicon carbide and nanoparticles. The level of incorporation of reinforcing and/or bulking filler is in accordance with the standards in the field of composite materials. It may be, for example, an amount of filler of from 1 to 80%, preferably frost 10 to 70% and especially between 20 and 60%.

For the “gravel packing” application, fillers known for their acid resistance, such as graphite and silicon carbide, are especially preferred.

It is possible, for example, to use a polyamide composition comprising from 5 to 40% by weight of novolac resin, and from 10 to 30% by weight of graphite or of silicon carbide, relative to the total weight of the composition.

The polyamide composition may also comprise one or more other polymers, preferably thermoplastic polymers such as polyamide, polyolefins, ABS or polyester.

The composition according to the invention may also comprise additives usually used for the manufacture of polyamide compositions intended to be molded. Thus, mention may be made of lubricants, flame retardants, plasticizers, nucleating agents, catalysts, agents for improving resilience, for instance optionally grafted elastomers, light and/or heat stabilizers, antioxidants, antistatic agents, dyes, pigments, matting agents, molding aids or other conventional additives.

For the preparation of a polyamide composition, these fillers and additives may be added to the polyamide via conventional means suited to each filler or additive, for instance during the polymerization or as a molten mixture. The novolac resin is preferentially added to the polyamide as a melt, especially during a step of extrusion of the polyamide, or as a solid in a mechanical mixer; the solid mixture may then be melted, for example via an extrusion process.

The polyamide composition comprising the novolac resin may also be used, as an additive, especially for imparting certain properties, especially rheological properties, to compositions comprising as matrix a thermoplastic polymer, especially a (co)polyamide. The invention thus relates to a process for manufacturing a composition in which a polyamide composition comprising novolac resin is mixed, without heating or as a melt, with a thermoplastic composition, especially based on (co)polyamide. The cold mixture may then be melted, for example via an extrusion process.

The polyamide composition comprising the novolac resin may also comprise a large proportion of additives and may be used, for example, as a masterbatch intended to be mixed with another thermoplastic composition, especially based on polyamide.

The compositions according to the invention may be used as raw material in the field of plastics processing, for example for the preparation of articles obtained by injection molding, by injection/blow-molding, by extrusion or by extrusion/blow-molding. According to a common embodiment, the modified polyamide is extruded in the form of rods, for example in a twin-screw extrusion device, which are then chopped into granules. The molded components are then prepared by melting the granules produced above and feeding the molten composition into injection-molding devices.

As articles according to the invention, mention may be made of pipes, tanks and containers, such as cooling tubes, cooling water housings, engine air guide hoses, hoses for the oil circuit.

According to another aspect, the polyamide composition of the invention may also be used as a filter (gravel pack) in the field of the recovery of muds, liquids and gases present in underground reservoirs, and in particular in the field of the extraction of hydrocarbons, such as crude oil or natural gas. For this purpose, the composition of the invention, advantageously in the form of calibrated particles as defined above, is introduced by pumping into the underground reservoir to act according to a filtration mechanism, in order to minimize the flow of fine particles of rock, sand and other impurities liable to be present in the reservoir, into the muds, liquids and gases that have to be extracted from the well. Such a “gravel packing” operation requires a few hundreds of kg to a few thousands of kg, for example around 0.5 tonne to around 5 tonnes of material according to the invention. For this application use may especially be made of calibrated particles, such as granules, pellets and/or cylinders, flattened or not, that have a mean particle size (D59) between 0.2 and 2 mm, preferably between 0.5 and 1.5 mm.

Thus, another subject of the invention is calibrated particles having a mean particle sixe (D50) between 0.2 and 2 mm comprising polyamide and a novolac resin. This mean particle size may be measured by laser particle size analysis or by screening according to the NF P18-560 standard. In particular, it is possible by successive screening to determine the mean particle size (D50) by weight. It is also possible to construct a diagram of the distribution of the size of the particles as a function of their weights and to measure the mean particle size (D50).

Specific language is used in the description so as to facilitate the understanding of the principle of the invention. It should, however, be understood that no limitation of the scope of the invention is envisioned by the use of this specific language. Modifications, improvements and refinements may especially be envisioned by those skilled in the art of the technical field concerned on the basis of their own general knowledge.

The term “and/or” includes the meanings “and”, “or” and also all the other possible combinations of the elements connected to this term.

Other details and advantages of the invention will emerge more clearly in the light of the examples below, which are given purely for indicative purposes.

### EXPERIMENTAL SECTION

The tests presented below are inspired by the API EP 58 (American Petroleum Institutes) standard.

### Procedure

### Sample Preparation

1) Polyamide PA-6,6 and variable proportions of novolac resin (Rhénosin RB) are melt blended in a twin-screw extruder.

2) Granules are obtained by chopping rods exiting the extruder. Pellets are also obtained by an underwater cutting process.

3) 15 g of pellets or of granules are placed in a crystallizing dish. Said pellets or granules are dried in an oven for 48 h under vacuum under a purge of nitrogen at 80° C. The pellets or granules are recovered, and placed in a desiccator in order to return them to ambient temperature. The water content of the polymer m_{water} is then measured with a Karl Fischer device.

### 65° C. Test for 30 Minutes in 15% HCl

5 g of sample to be tested are weighed with a D 329METTLER AE 240 laboratory balance (accuracy: 3.10⁻³ g). The initial mass m_{polymer}^{o} is thus obtained. The sample is placed in a 250 ml flat-bottomed reactor. 100 ml of a 15% hydrochloric acid solution (solution prepared by diluting a 30% hydrochloric acid solution) are added. The measuring cylinder used has an accuracy of +/−1.0 ml at 20° C. The reactor is sealed. The test is carried out without stirring. A slight purge of nitrogen is used (verification owing to the bubbler at the inlet and outlet of the reactor). The reactor is immersed in an oil bath at 65° C. and the timer is started as soon as the reactor is immersed. The test lasts 30 min.

At the end of the test, the reactor is disassembled and the solution is filtered through a pleated filter paper. It is rinsed with demineralized water and the pH is measured.

The filtered substance is recovered and placed in a beaker. 200 ml of demineralized water are added with a magnetic stirrer and the beaker is placed on a stirrer plate for one hour. Then the pH is checked with pH paper in order to follow the change in the concentration of HCl. It is rewashed twice noting the pH at the end of each washing process.

At the end of the washing processes, the substance is recovered in an aluminum dish. The substance is left overnight under a ventilated fume hood. Finally the filter paper is weighed.

The substance is dried in an oven for 48 h under vacuum under a purge of nitrogen at 80° C. The substance is then placed in a desiccator in order for it to return to ambient temperature. The substance is weighed and the final mass m_{polymer}^{f} is thus obtained.

Observation: an assay of the chlorides after the test was carried out on several sample. Around 0.12% of Cl⁻ remains in the sample. The water assay indicates a water content of around 0.42% after the acid test.

### Expression of the Results

The mass loss (ML) is measured by the following equation:

ML=[m_{polymer}^{o}−m_{polymer}^{f})/m_{polymer}^{o}]*100±0.5%

A mass loss of 11% is observed with a composition comprising a polyamide PA-6,6, a mass loss of only 0.7% with a composition comprising a polyamide PA-6,6 and 25% by weight of novolac resin, and a mass loss of only 1.5% with a composition comprising a polyamide PA-6,6 and 10% by weight of novolac resin (novolac by weight, relative to the total weight of the composition).

1. A method for increasing the acid resistance of a polyamide composition, comprising: adding a novolac resin comprising a condensation product of a phenolic compound with an aldehyde or a ketone to the polyamide composition for increasing the acid resistance of a polyamide composition.

2. The method as claimed in claim 1, characterized in that the polyamide is selected from the group consisting of the polyamide PA-6, the polyamide PA-6,6, the polyamide PA-6,10, the polyamide PA-11, the polyamide PA-12, the polyamide PA-6,12, poly (meta-xylylene adipamide), the polyamide PA-6,6/6,T, the polyamide PA-6,6/,6,1, and blends and copolyamides.

3. The method as claimed in claim 1, characterized in that said composition comprises from 40 to 90% by weight of polyamide, relative to the total weight of the composition.

4. The method as claimed in claim 1, characterized in that the composition comprises from 5 to 40% by weight of novolac resin, relative to the total weight of the composition.

5. The method as claimed in claim 4, characterized in that the novolac resin has a degree of condensation between 2 and 15.

6. The method as claimed in claim 5, characterized in that the novolac resin is a condensation product of phenol and formaldehyde.

7. The method as claimed in claim 6, characterized in that the novolac resin has a molecular weight between 500 and 3000 g/mol, preferably between 800 and 2000 g/mol.

8. The method as claimed in claim 3, characterized in that the polyamide composition comprises at least one reinforcing and/or bulking filler, selected from the group consisting of glass fibers, carbon fibers, aramid fibers, clays, kaolin, mica, wollastonite, silica, talc, graphite, silicon carbide and nanoparticles.

9. The method as claimed in claim 1, further comprising: using, the polyamide composition as a filter in the field of the recovery of muds, liquids and gases present in underground reservoirs.

10. A calibrated particle having a mean particle size (D50) between 0.2 and 2 mm comprising polyamide and a novolac resin as claimed in claim 1.

11. The method of claim 9, wherein the polyamide composition is used as a filter in the field of the extraction of hydrocarbons.

12. The method of claim 11, wherein the hydrocarbons are selected from the group of crude oil and natural gas.

13. The method of claim 1, further comprising: forming an article comprising a composition comprising the novolac resin and the polyamide composition, wherein the article has increased acid resistance to a corresponding article free of the novolac resin.

14. The method of claim 13, wherein the article is a filter.
